(19) United States
(12) Patent Application Publication
(10) Pub. No.: US 2026/0042370 A1
(43) Pub. Date: Feb. 12, 2026

(54) METHOD OF EV BATTERY NOMINAL ZONE-AWARE CHARGING COMMUNICATION

(71) Applicant: National Taiwan University, Taipei City (TW)

(72) Inventors: Yi-Yun Li, Yunlin County (TW); Hung-Yu Wei, Taipei (TW)

(73) Assignee: National Taiwan University, Taipei City (TW)

(21) Appl. No.: 18/976,656

(22) Filed: Dec. 11, 2024

(30) Foreign Application Priority Data
Aug. 12, 2024 (TW) 113130221

(51) Int. Cl. B60L 53/62; B60L 53/65; B60L 58/12

(52) U.S. Cl. CPC B60L 53/62; B60L 53/65; B60L 58/12; B60L 2240/545

(57) ABSTRACT

A method of electric vehicle (EV) battery nominal zone-aware charging communication executed by an supply equipment communication controller (SECC) of an EV supply equipment (EVSE), the SECC establishes a communication connection with an EVCC of an EV, and the method includes the following: (a) receiving a service selection message from the EVCC; (b) receiving a battery characteristics report request message from the EVCC; (c) based on the messages received from the EVCC, estimating a nominal zone of the battery for charging and discharging and planning a charging schedule for EV battery nominal zone-aware charging; (d) during the charging and discharging of the battery, the SECC receives from the EVCC a present state of charge (SOC) of the battery and a present status of the battery to execute the charging schedule for the EV battery nominal zone-aware charging, so as to avoid accelerated battery degradation and to extend battery lifetime.

### CROSS REFERENCE TO RELATED APPLICATION(S)

This application claims the priority to patent application No. 113130221 filed in Taiwan on Aug. 12, 2024, which is hereby incorporated in its entirety by reference into the present application.

### BACKGROUND OF THE INVENTION

### 1. Field of the Invention

The present invention relates to charging communication for electric vehicles (EV), in particular to a method of EV battery nominal zone-aware charging communication.

### 2. Description of the Related Art

Charging electric vehicles requires high current and power, and usually has additional requirements for time, efficiency and safety. However, battery charging/discharging is complicated, and an electric vehicle supply equipment (EVSE) not only has to meet the above-mentioned requirements of high current, high power, charging time, charging efficiency and charging safety for electric vehicles, but also has to consider the lifetime of the battery. Therefore, how to further avoid accelerated battery degradation due to charging/discharging to extend lifetime of the battery is an issue that deserves continuous attention.

### SUMMARY OF THE INVENTION

In view of the above-mentioned issues, the present invention is mainly concerned with providing a method of EV battery nominal zone-aware charging communication in order to avoid accelerated battery degradation so as to achieve the main objective of the present invention.

The present invention provides a method of EV battery nominal zone-aware charging communication, executed by a supply equipment communication controller (SECC) of an electric vehicle supply equipment (EVSE), the SECC establishing a communication connection with an EV Communication Controller (EVCC) of an electric vehicle (EV), and the SECC executing a dynamic control mode, and the method of EV nominal zone-aware charging communication comprises the following steps:
(a) receiving a service selection message from the EVCC to confirm that a battery of the EV is to be charged or discharged in a DC bidirectional power transfer charge/discharge mode or in an AC bidirectional power transfer charge/discharge mode;
(b) receiving from the EVCC a battery characteristics report request message for the battery containing a battery type element, a battery nominal zone boundary estimation method, and a battery operating temperature, or either one of a nominal zone boundary state of charge (SOC) and a discharge curve parameter;
(c) based on the messages received from the EVCC, estimating a nominal zone of the battery for charging and discharging and planning a charging schedule for EV battery nominal zone-aware charging; and
(d) during the charging and discharging of the battery, the SECC receiving from the EVCC a present SOC, a present temperature, a present voltage, and a present current of the battery in order to execute the charging schedule for the EV battery nominal zone-aware charging.

Preferably, in step (b), when the battery nominal zone boundary estimation method is a default SOC battery nominal zone estimation method, a boundary of the battery nominal zone of the battery is further set to be a lower boundary SOC value and an upper boundary SOC value, so as to avoid the battery SOC being lower than the lower boundary SOC value or higher than the upper boundary SOC value during charging and discharging of the battery.

Preferably, in step (b), when the battery nominal zone boundary estimation method is a reported SOC nominal zone boundary estimation method, SOC values of a boundary of the battery nominal zone of the battery are further obtained from a battery characteristics report request message sent by the EVCC for calculating the battery nominal zone of the battery, so as to avoid the charging/discharging profile of the battery exceeding the boundary of the battery nominal zone of the battery during charging/discharging of the battery.

Preferably, in step (b), when the battery nominal zone boundary estimation method is a discharge curve nominal zone boundary estimation method, the SECC adopts a battery discharge curve model in estimating a boundary of the battery nominal zone of the battery to calculate a present discharge profile, and estimates a nominal charge/discharge zone for the battery based on the present discharge profile.

The present invention discloses that the SECC 3 of the EVSE 2 executes the dynamic control mode, wherein the SECC 3 obtains battery related information of the EV 4 through the EVCC 5, and adopts one of three battery nominal zone boundary estimation methods according to the instructions of the EVCC 5, and the EVCC 5 further provides corresponding data for the adopted battery nominal zone boundary estimation method to enable the SECC 3 to accordingly estimate a battery nominal zone for charging and discharging, and to plan/adjust and execute a charging schedule taking into account the EV battery charging and discharging nominal zone which prevents accelerated battery degradation due to exceeding the nominal zone during battery charging or discharging, and thereby the objective of extending the lifetime of the battery can be achieved.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 illustrates a block diagram of the electric vehicle (EV) and the EV supply equipment (EVSE) used in the method of the invention.

FIG. 2 illustrates a schematic flow diagram of the method of the present invention.

FIGS. 3A to 3E illustrate schematic flow diagrams of an embodiment of the method of the present invention for ISO 15118-20.

FIGS. 4A to 4E illustrate schematic flow diagrams of an embodiment of the method of the present invention for ISO 15118-20.

FIGS. 5A to 5E illustrate schematic flow diagrams of an embodiment of the method of the present invention for ISO 15118-20.

FIGS. 6A to 6E illustrate schematic flow diagrams of an embodiment of the method of the present invention for ISO 15118-20.

FIGS. 7A to 7E illustrate schematic flow diagrams of an embodiment of the method of the present invention for ISO 15118-20.

FIGS. 8A to 8E illustrate schematic flow diagrams of an embodiment of the method of the present invention for ISO 15118-20.

### DETAILED DESCRIPTION OF THE INVENTION

The technical contents, features and effects of the present invention will be clearly presented in the following detailed description of the preferred embodiment with reference to the drawings. In addition, the directional terms mentioned in the following embodiments, such as: up, down, left, right, front, back, bottom, top, etc., are only relative directions with reference to the drawings, and do not represent absolute directional positions; therefore, the directional terms used are for the convenience of illustrating their relative positional relationships, and are not intended to impose limitations on the present invention.

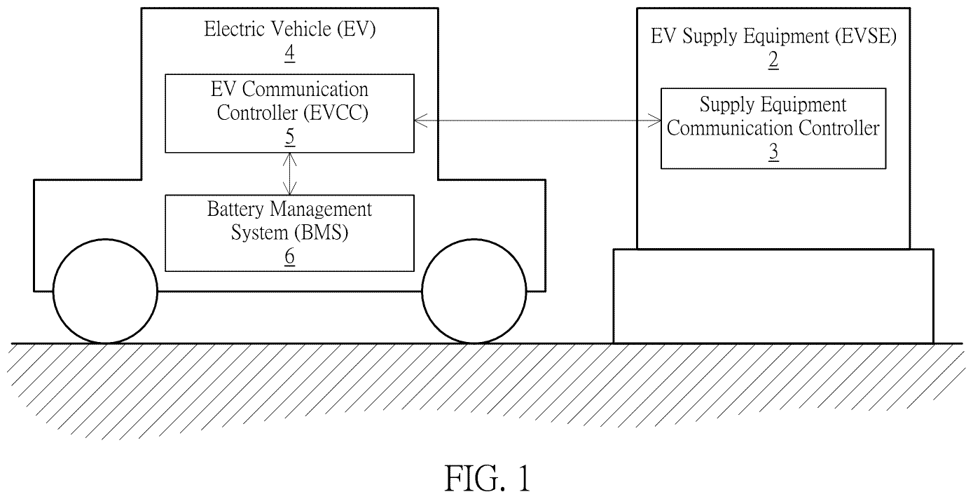

Please refer to FIG. 1: the present invention of a method of EV battery nominal zone-aware charging communication is executed by a supply equipment communication controller (SECC) 3 located in an electric vehicle supply equipment (EVSE) 2 which is connected to an Electric Vehicle Communication Controller (EVCC) 5 located at an electric vehicle (EV) 4. The SECC 3 and the EVCC 5 of the EV 4 can carry out bi-directional transmission of information. The EVCC 5 is also connected to a battery management system (BMS) 6 of the EV 4 to obtain various specifications of batteries as well as relevant battery physical parameters and operation status currently sensed, and to control the charging and discharging of the batteries.

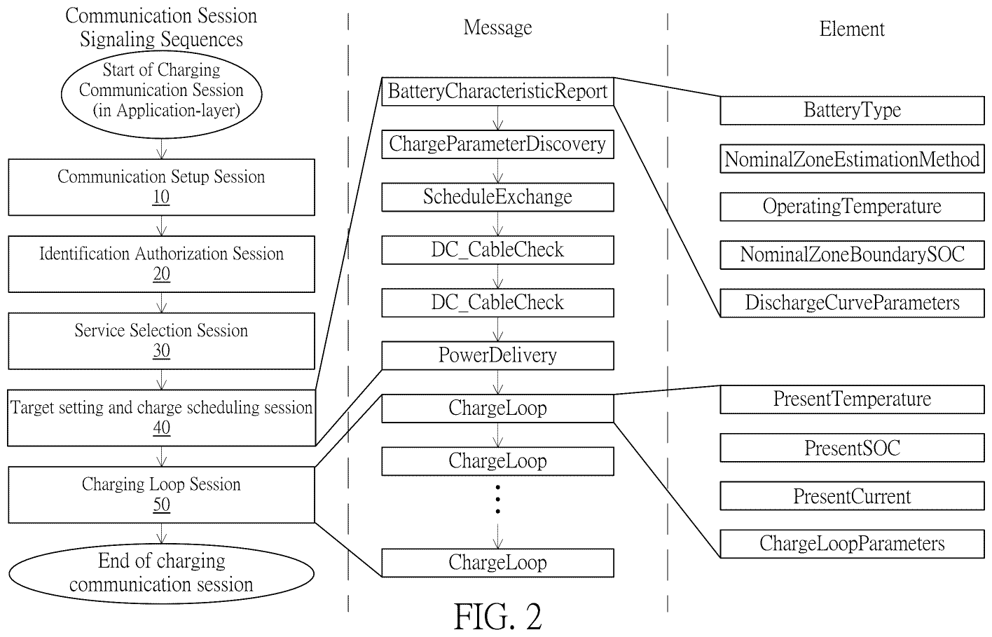

Please refer to FIG. 2: in one embodiment, the SECC 3 and the EVCC 5 may share battery information of the EV 4 and the EVSE 2 information, and follow a charging/discharging schedule to charge/discharge the battery via Vehicle-to-Grid (V2G) communication session signaling sequences. The communication between the SECC 3 and the EVCC 5 is based on, but not limited to, ISO 15118-20 standard published by the International Organization for Standardization (ISO). The SECC 3 and the EVCC 5 can communicate in an application layer, which mainly includes Communication Setup Session 10, Identification, Authorization Session 20, Service Selection Session 30, Target Setting and Service Selection Session 40, Charging Loop Session 50, and End of Charging Communication Session between the SECC 3 and the EVCC 5. The SECC 3 and the EVCC 5 can communicate with each other by transmitting a message, the information contained in the message is called element, and the SECC 3 and the EVCC 5 can write the element information into the message, and at the same time, the SECC 3 and the EVCC 5 can read the contents of the message and the element.

In one embodiment of the present invention, the charging mode of the EVSE 2 includes a Bi-directional Power Transfer (BPT) mode in which charging power can be allowed to flow not only from the EVSE 2 to the EV 4 but also from the EV 4 back to the EVSE 2. Further, the charging mode of the EVSE 2 also has an AC or a DC operation mode. In addition, the SECC 3 of the EVSE 2 can run in a dynamic control mode, which means that charge schedules of the EV 4 are dynamically determined by the EVSE 2 according to the electricity load and the power provided by the nearby grid. Based on the mobility information from the EVCC 5 (which includes elements such as Departure Time, MinimumSOC, TargetSOC of the EV 4), the EVSE 2 can calculate a charge schedule that is consistent with charge target/timeline of the EV 4.

In order to avoid accelerated battery degradation due to improper charging/discharging, in one embodiment of the present invention, the EVSE 2 also takes into account a nominal zone of the battery of the EV 4 when calculating a charge profile of the battery of the EV 4. The nominal zone of the battery refers to an operating region of the state of charge (SOC) of the battery in which the battery voltage and the SOC of the battery are in a linear relationship, where charging and discharging the battery of the EV 4 does not result in said accelerated battery degradation. Outside the operating region, the battery voltage and the SOC of the battery have an exponential relationship, and charging and discharging the battery of the EV 4 will result in said accelerated battery degradation. As the EV 4 in the dynamic control mode allows the EVSE 2 to determine the charging/discharging schedule of the battery of the EV 4, the EVSE 2 may repeatedly discharge the EV 4 when the load of the nearby grid is high, and repeatedly charge the EV 4 when the load of the nearby grid is low. This will result in a degradation of the performance of the battery of the EV 4, as the SOC of the battery during charging may be higher than an upper boundary of the nominal zone or the SOC of the battery during discharging may be lower than a lower boundary of the nominal zone. Accordingly, the present invention proposes a requirement that the EVCC 5 should transmit related parameters of the nominal zone of the battery of the EV 4 to the SECC 3 of the EVSE 2, so that the EVSE 2 can thereby calculate the charging schedule for the EV battery nominal zone-aware charging of the present invention.

Accurate estimation of the nominal zone is essential to prevent accelerated battery degradation due to exceeding the nominal zone during battery charging or discharging, and the present invention discloses the following three battery nominal zone boundary estimation methods, each having a different degree of accuracy and complexity of estimation.

As mentioned above, in one embodiment of the present invention, a default state-of-charge (SOC) nominal zone boundary estimation method is disclosed as follows:

In general, a battery nominal zone is defined by specifying a lower boundary and an upper boundary of a battery's SOC; for example, the lower boundary is around SOC 15% and the upper boundary is around SOC 85%, accordingly the default state-of-charge (SOC) nominal zone boundary estimation method respectively sets an upper boundary and a lower boundary of a battery nominal zone as the upper and lower boundaries of the SOC of the battery, even though setting the boundary of a battery nominal zone as the upper and lower boundaries of SOC of a battery is not absolutely accurate, however, it does help the EVSE 2 to prevent overcharging or over-discharging during repeated charging/discharging the battery of the EV 4. In the default SOC nominal zone boundary estimation method the EVSE 2 first defines a default SOC of the battery and uses the default SOC of the battery as an estimation value, so that the EV 4 does not need to report its own battery's nominal zone information to the EVSE 2. During the charging process, when the request and response are exchanged in a ChargeLoop message between the EVCC 5 and the SECC 3, the EVCC 5 is requested to report a battery's present SOC (PresentSOC) element of the battery of the EV 4 to the EVSE 2 so that the EVSE 2 can plan the charge profile to ensure that the battery of the EV 4 is not overcharged or over-discharged.

In one embodiment of the present invention, a reported state-of-charge (SOC) nominal zone boundary estimation method is disclosed as follows: The default SOC values in the EVSE 2 do not exactly match the nominal zone boundary of charging/discharging process for each EV, as the boundary of the nominal zone for each battery's charging/discharging process vary by battery type and change as the number of battery charge cycles increases. In the reported state-of-charge (SOC) nominal zone boundary estimation method, the EVSE 2 obtains the boundary SOC values of the nominal zone of the battery of the EV 4 from a battery characteristics report request message (BatteryCharacteristicReportReq) sent by the EVCC 5. The EV 4 analyses the boundary of its battery nominal zone and reports it to the EVSE 2 via elements of the BatteryCharacteristicReportReq message, namely: a NominalZoneLowerBoundarySOC element for a lower boundary SOC of the nominal zone and a NominalZoneUpperBoundarySOC element for an upper boundary SOC of the nominal zone. During charging, when the EVCC 5 reports the present SOC of the EV 4 to the EVSE 2 with the PresentSOC element in the ChargeLoop message, the EVSE 2 may arrange a charging profile that does not cause the SOC of the battery of the EV 4 to exceed the boundary of the battery nominal zone. In this way, the accelerated battery degradation caused by charging beyond the boundary of the battery nominal zone can be reduced.

In one embodiment of the present invention, a discharge curve nominal zone boundary estimation method is disclosed as follows:

Compared to the default SOC nominal zone boundary estimation method and the reported SOC nominal zone boundary estimation method, the discharge curve nominal zone boundary estimation method is the most accurate. The nominal zone boundary of a battery varies according to a number of factors, including not only the battery type, the number of battery charging cycles, but also the temperature and the charging/discharging current, and these factors change dynamically during each charging/discharging process. The battery SOC reported by the EVCC 5 to the EVSE 2 does not yet adequately reflect these dynamic changes, and therefore the afore-mentioned reported SOC nominal zone boundary estimation method is not yet an accurate estimation. The discharge curve nominal zone boundary estimation method allows the EVSE 2 to use a battery discharge curve model to evaluate the boundary of the battery nominal zone, and thus the number of battery charge cycles, temperature, and charging/discharging current are all taken into account. In the dynamic control mode defined by ISO 15118-20, the EVSE 2 can freely plan the charging schedule because it can calculate the present discharge profile with temperature and charging/discharging current parameters, so that the battery nominal zone can be handled and controlled by the EVSE 2.

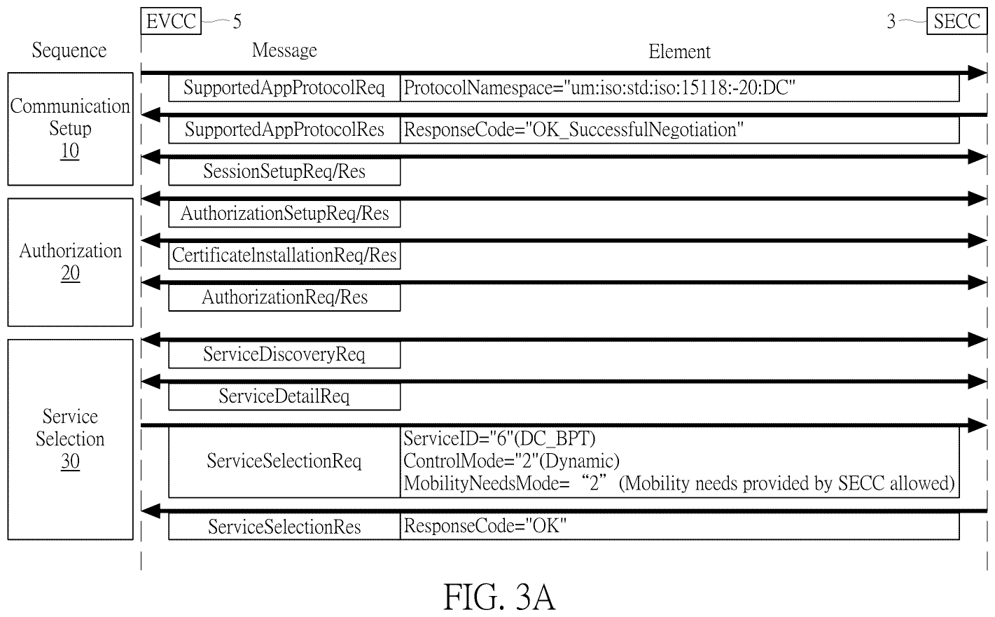

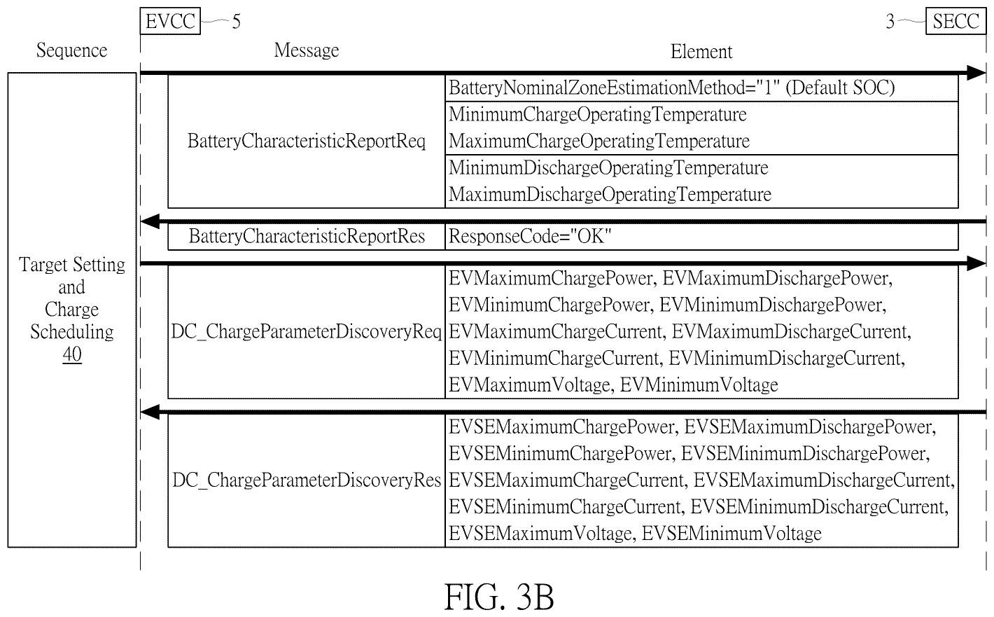

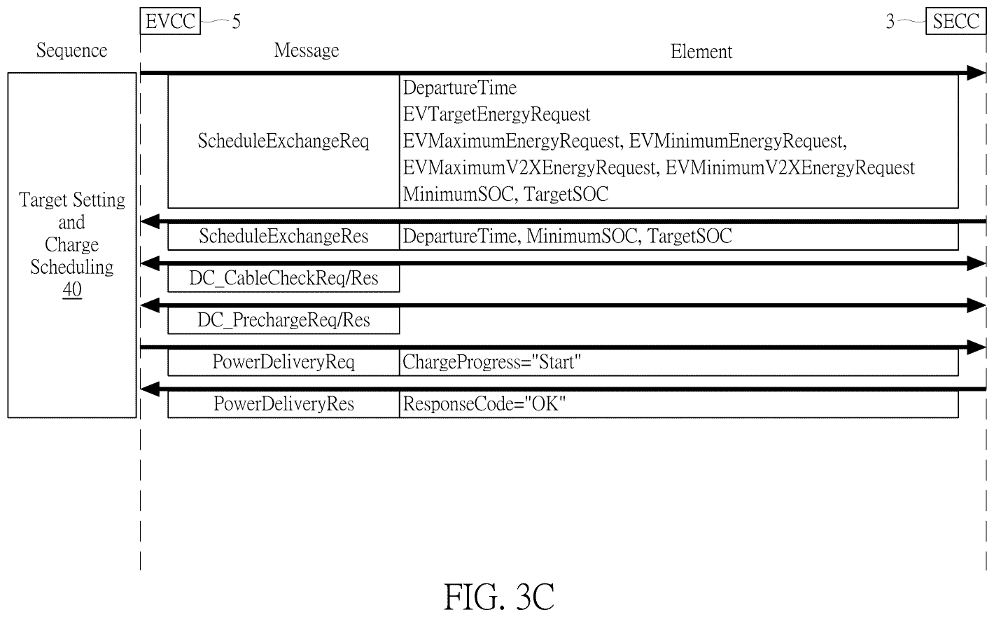

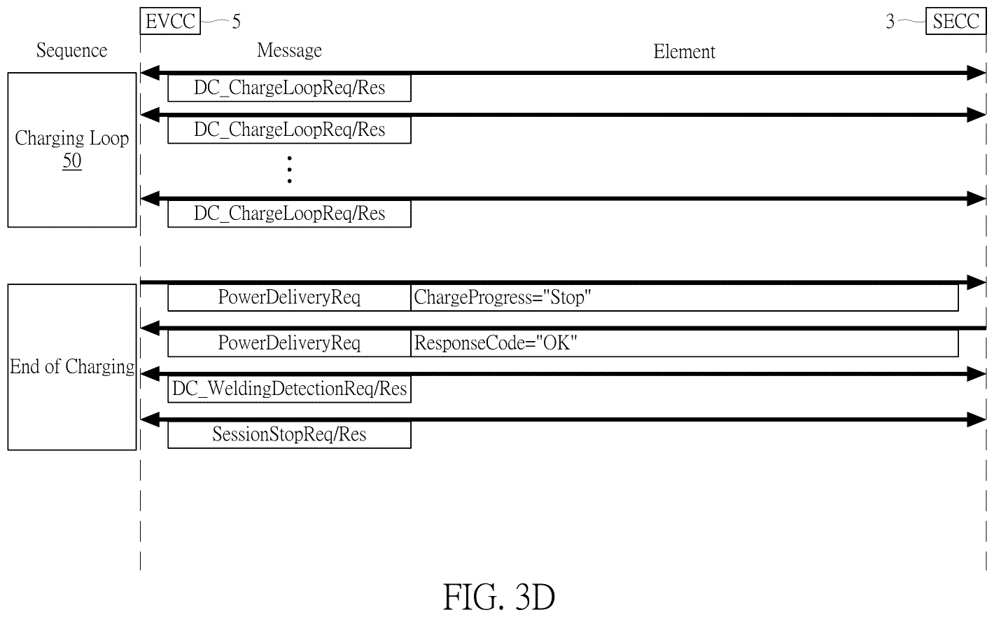

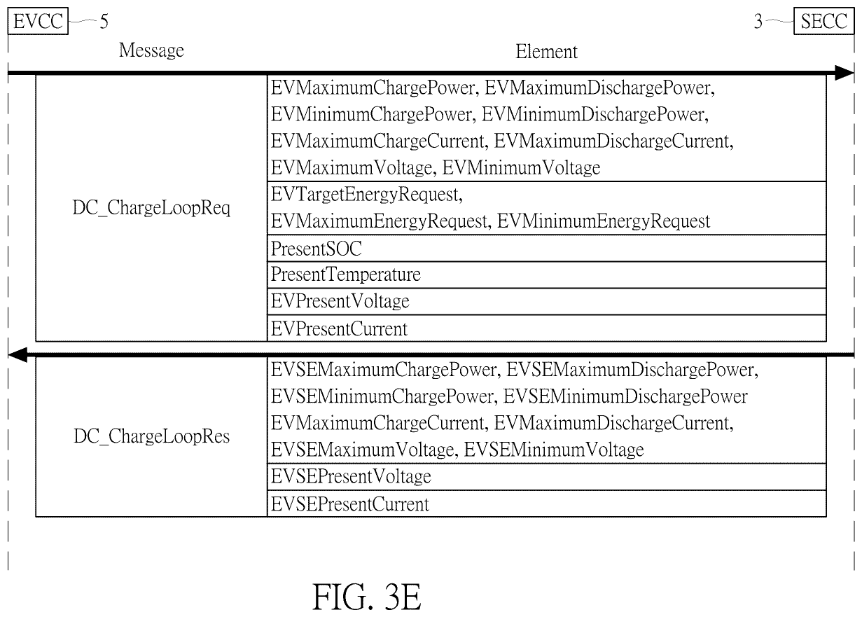

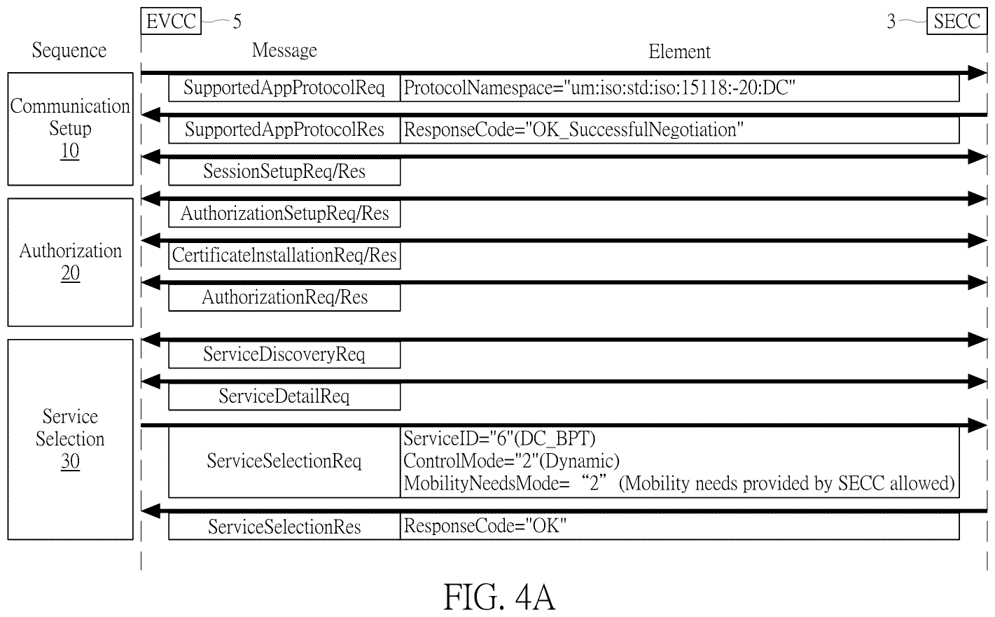

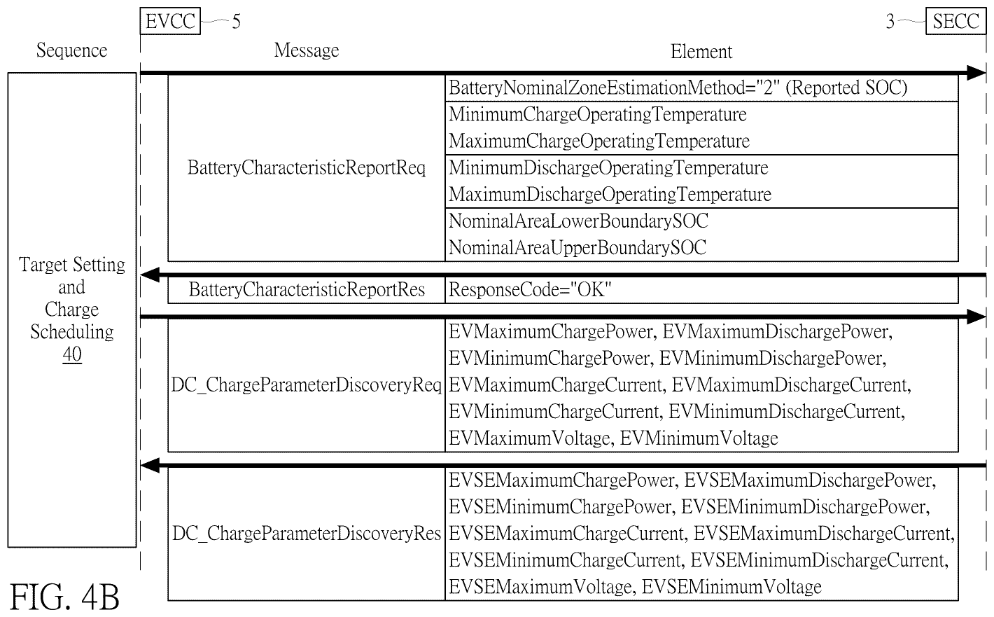

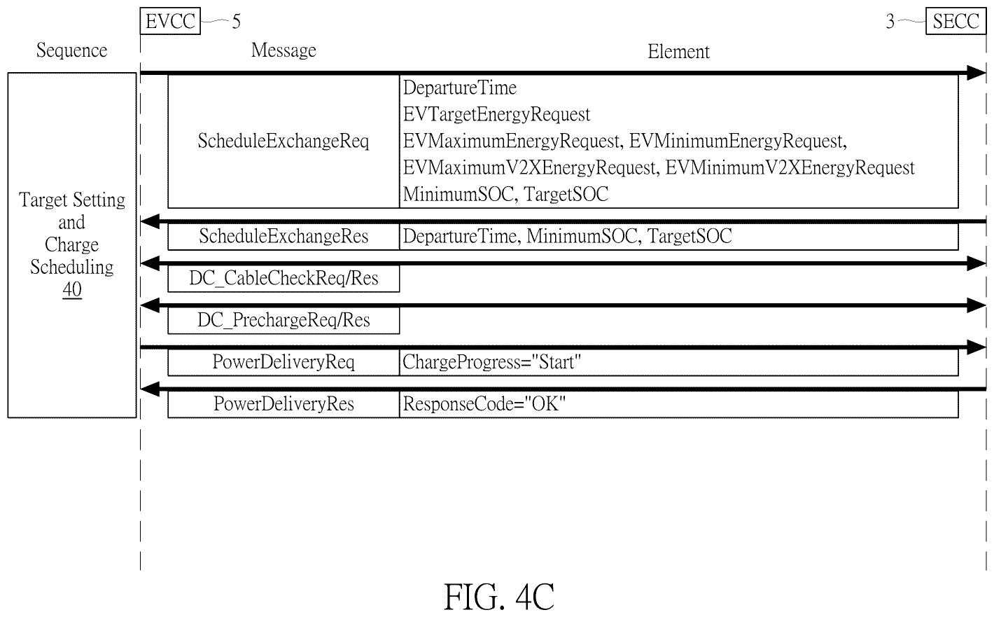

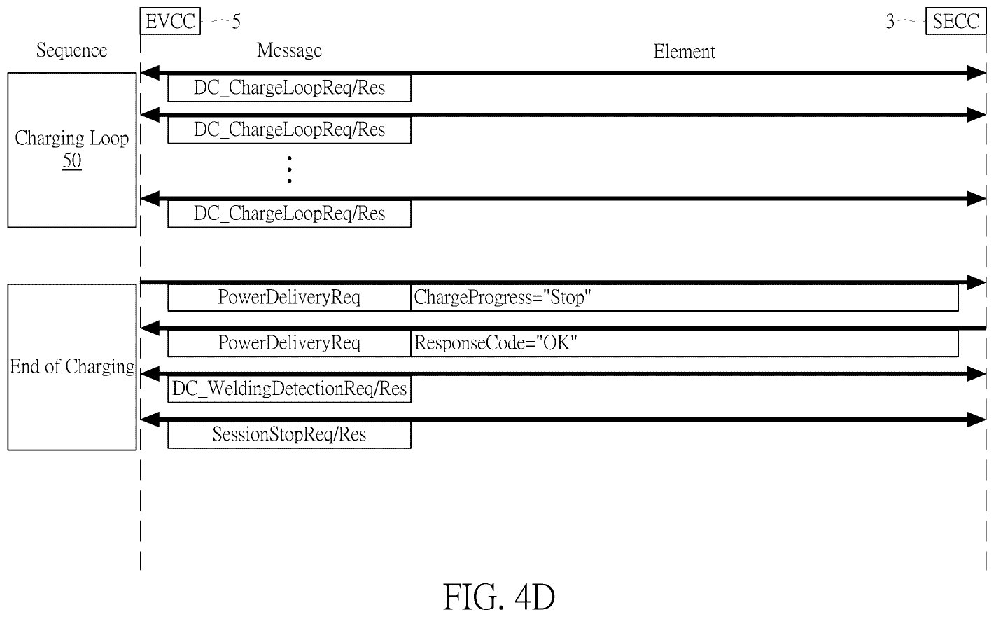

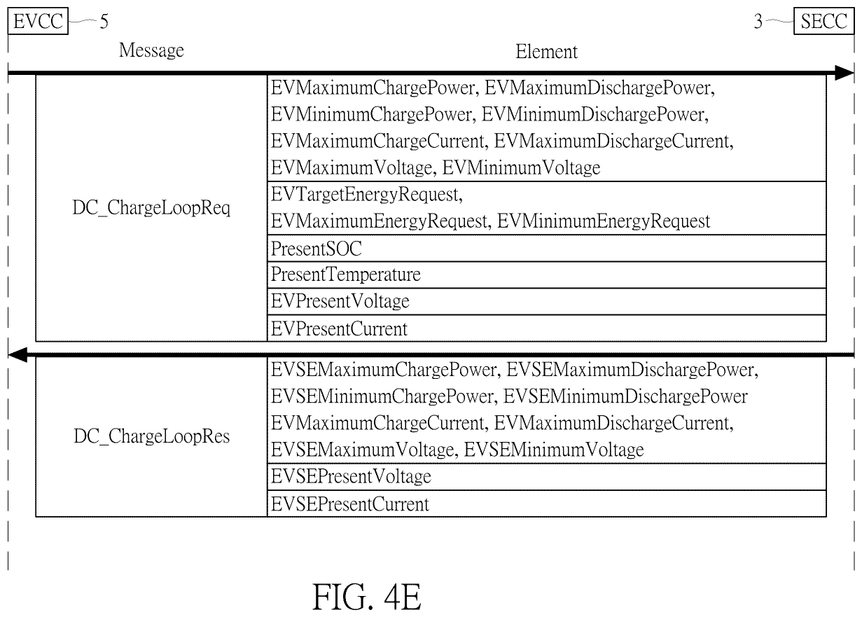

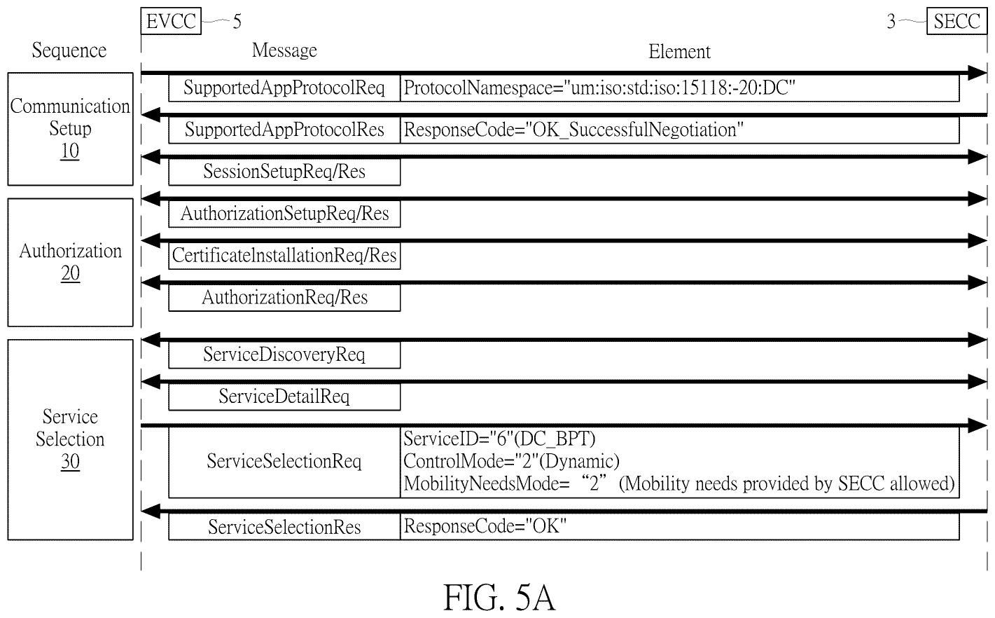

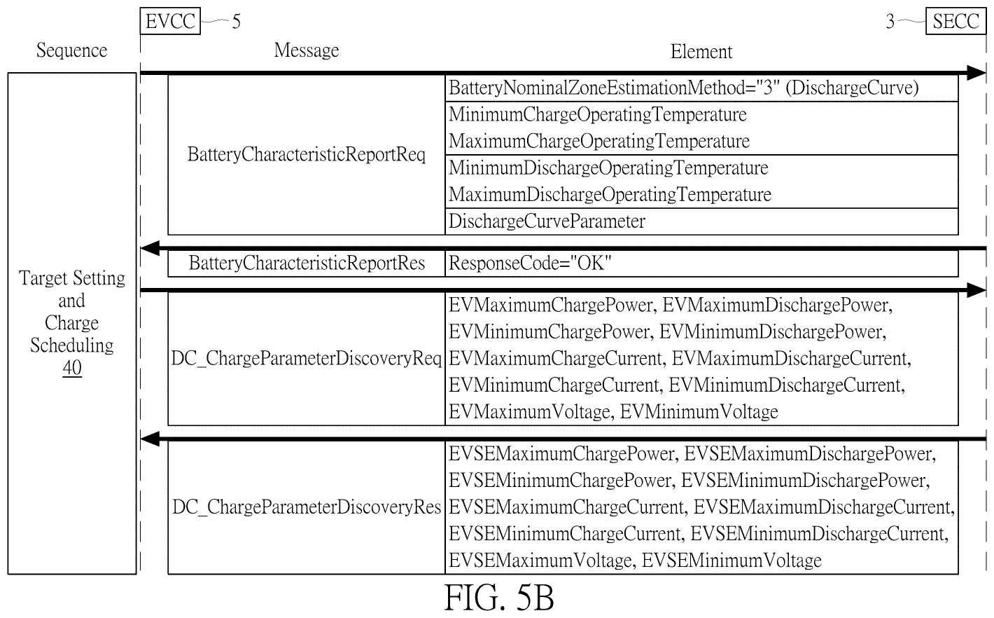

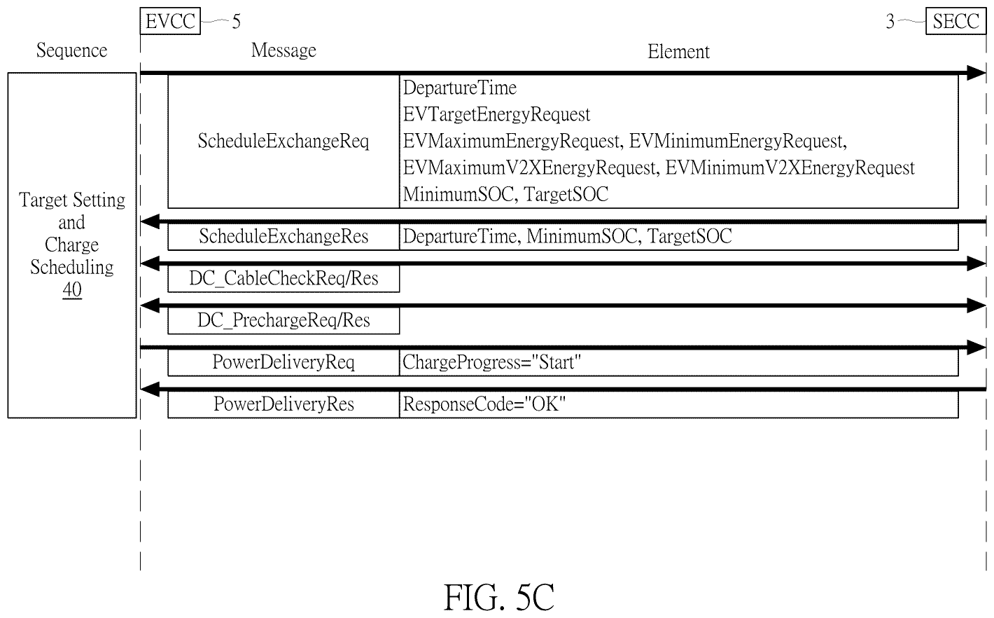

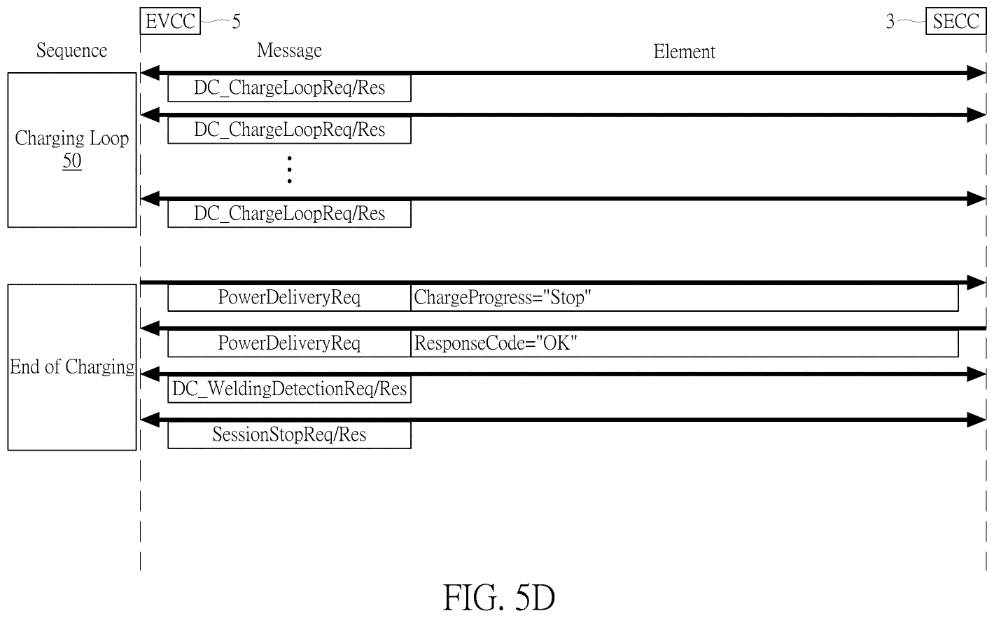

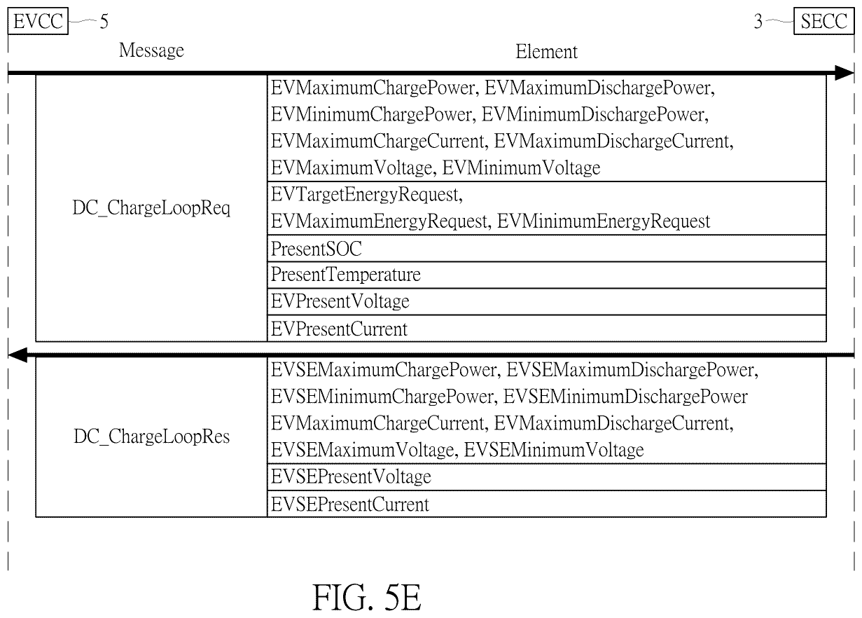

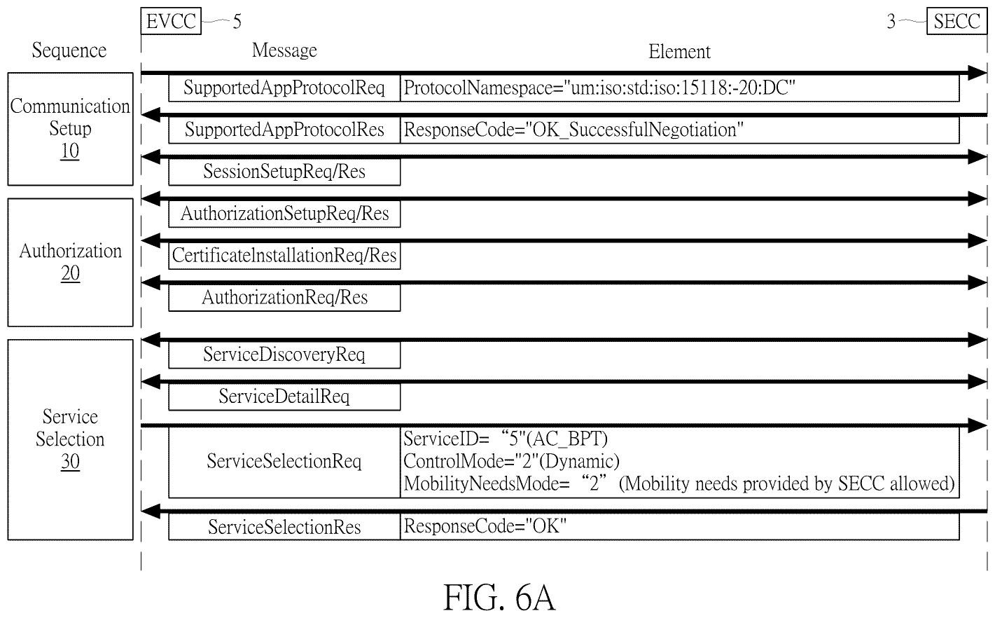

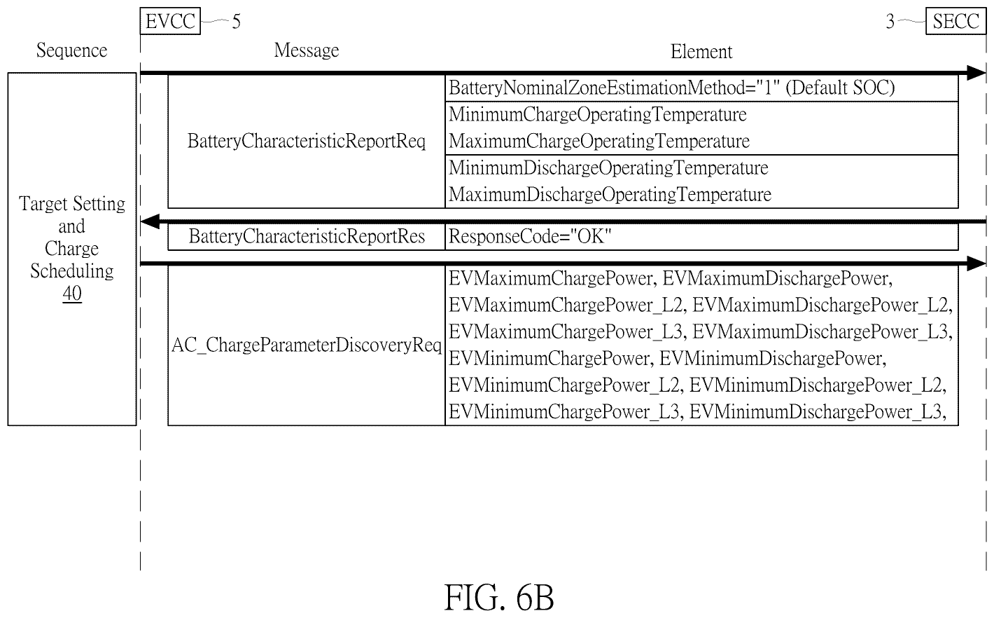

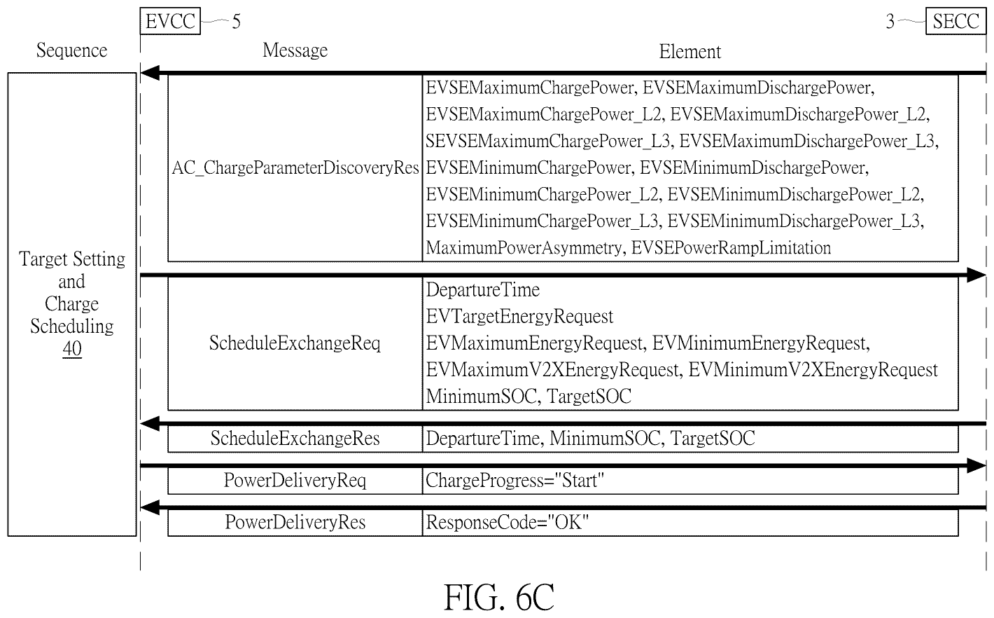

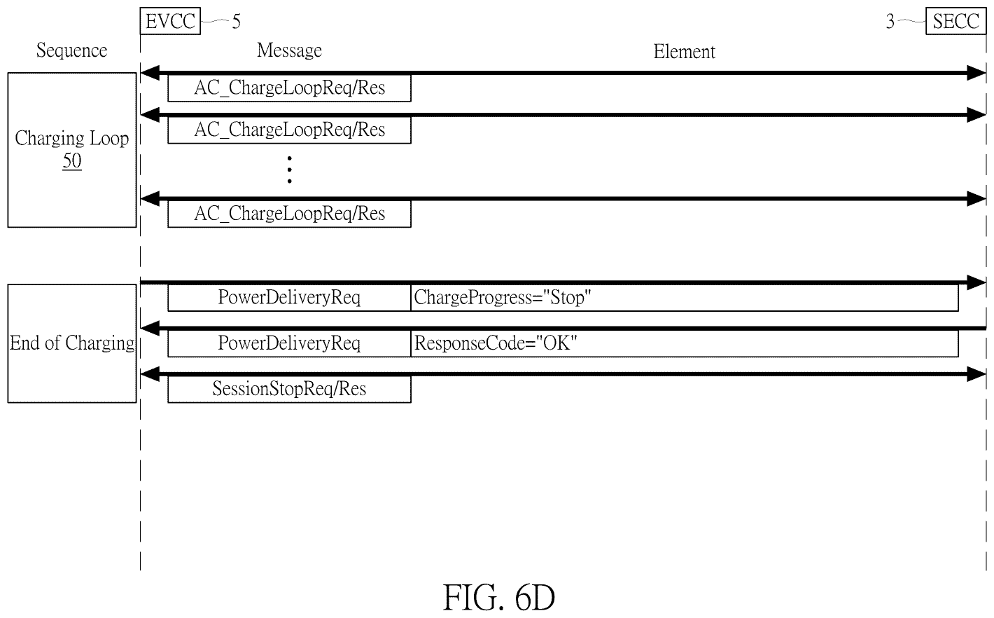

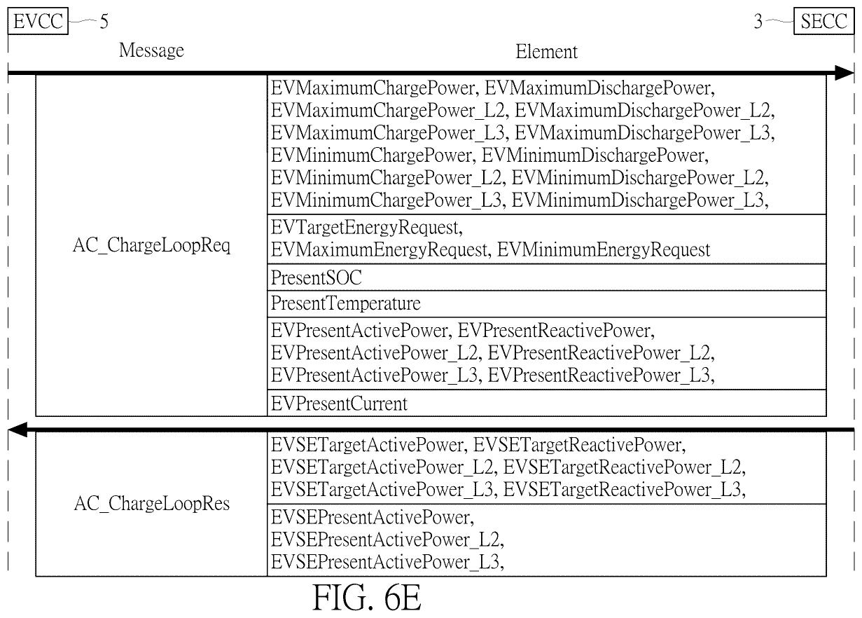

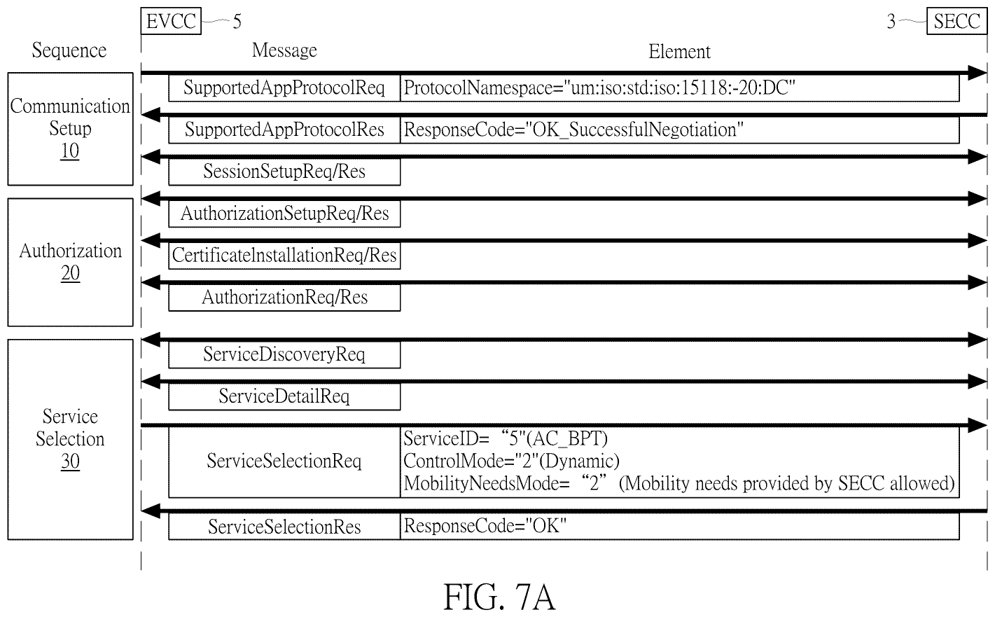

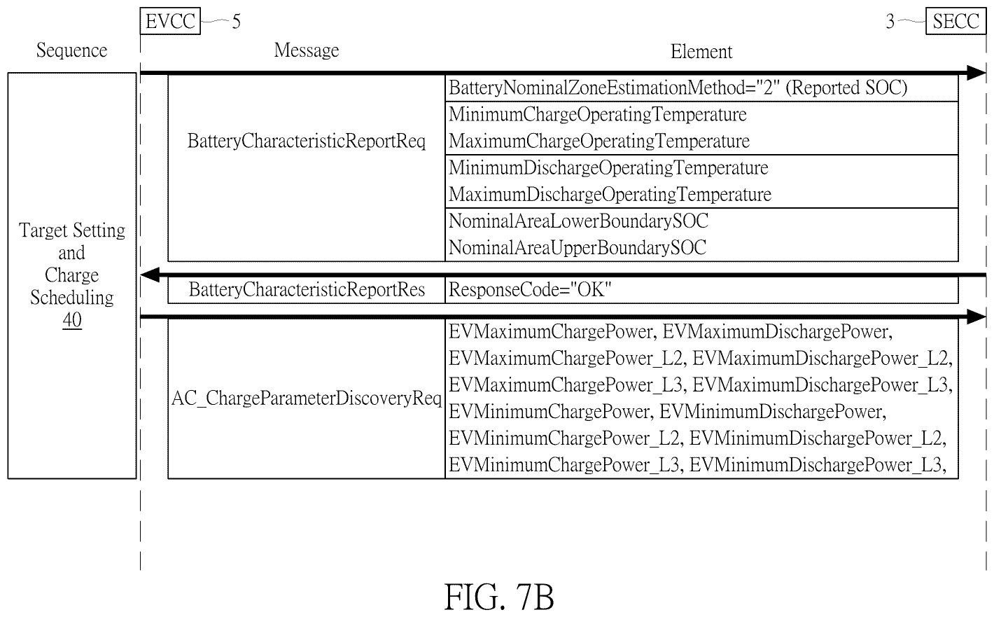

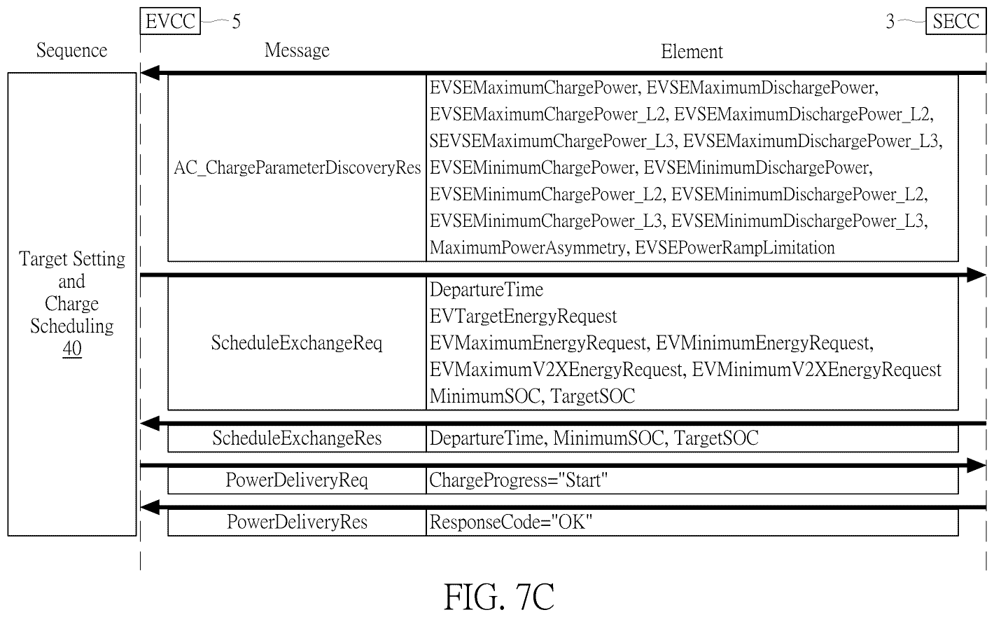

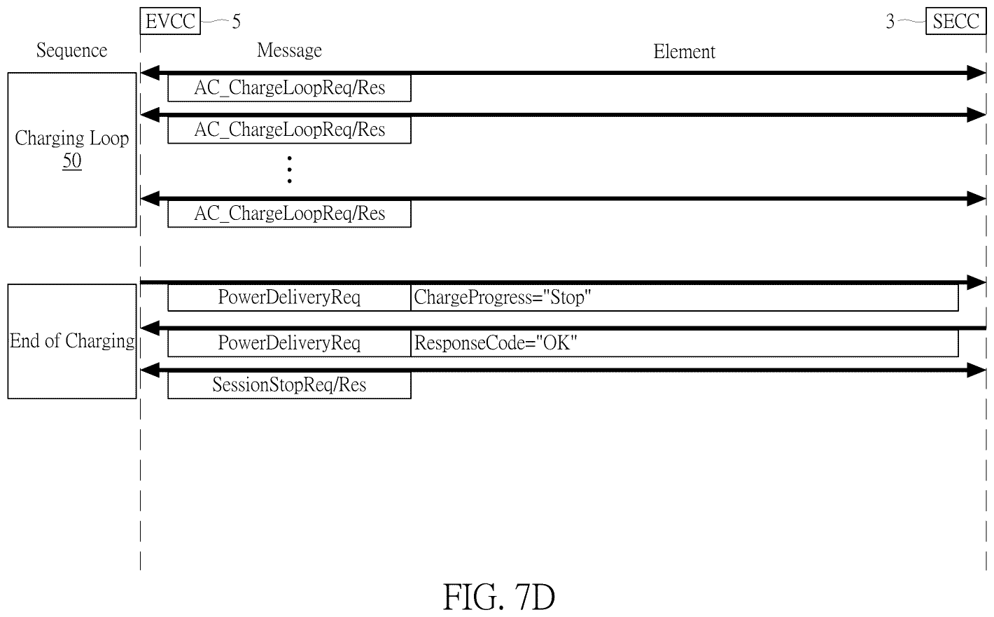

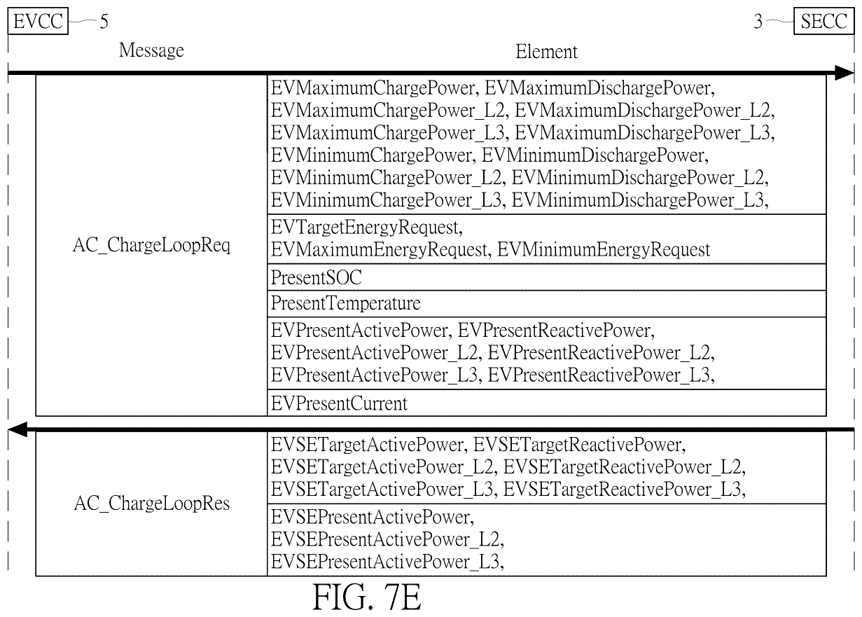

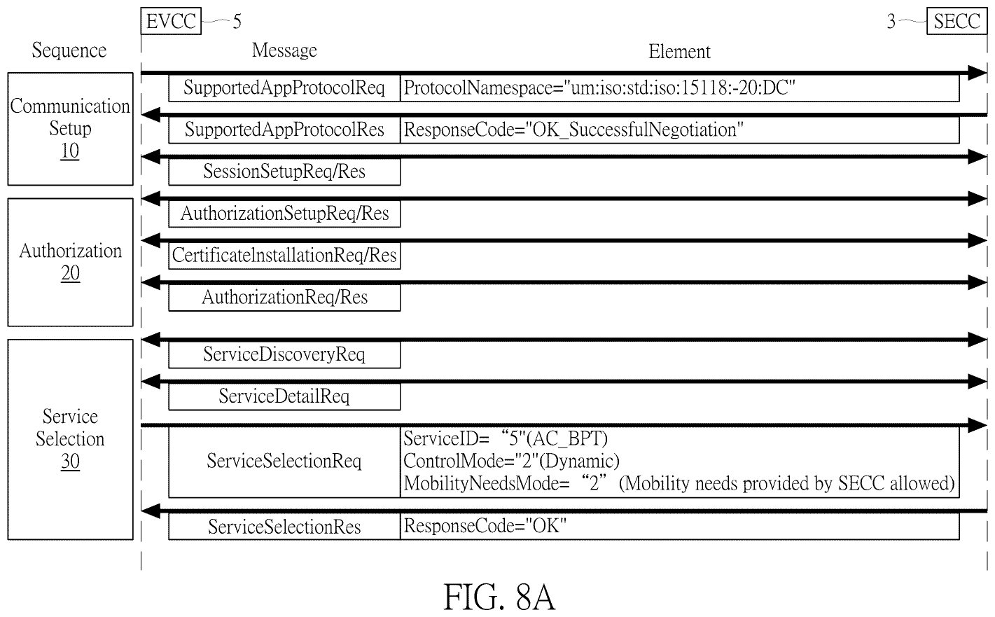

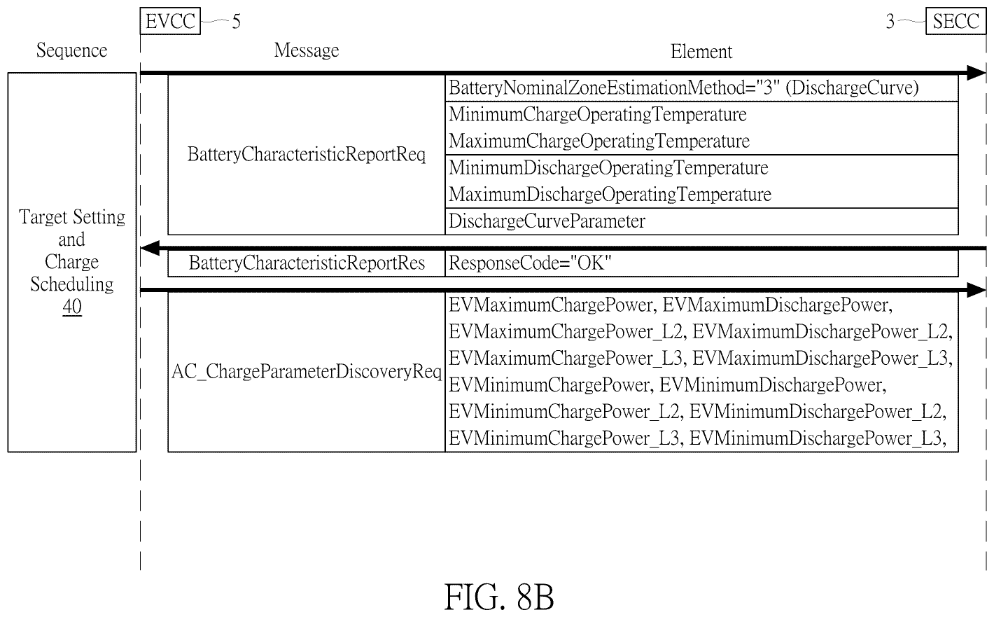

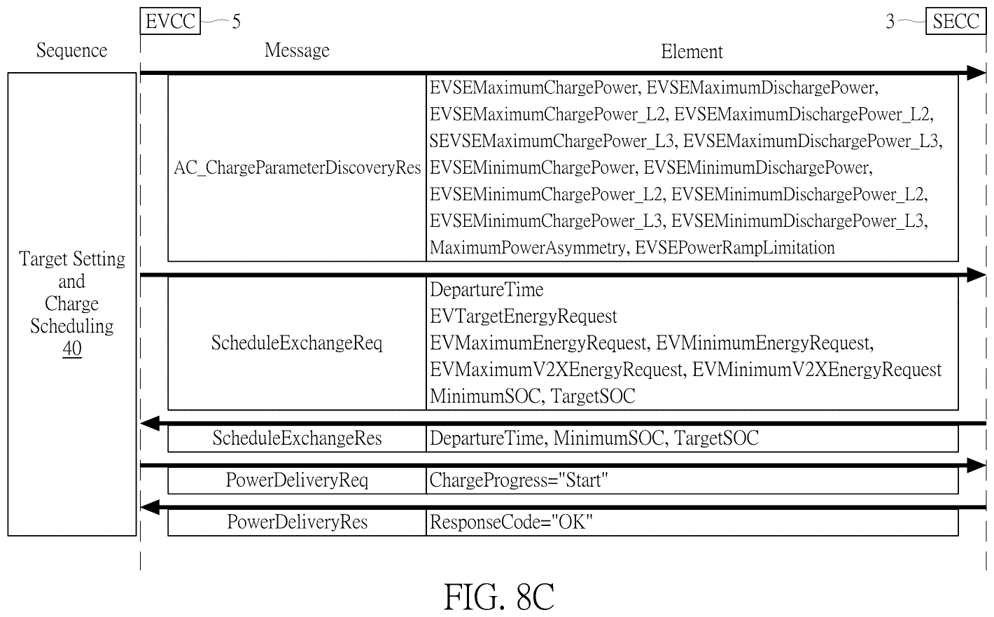

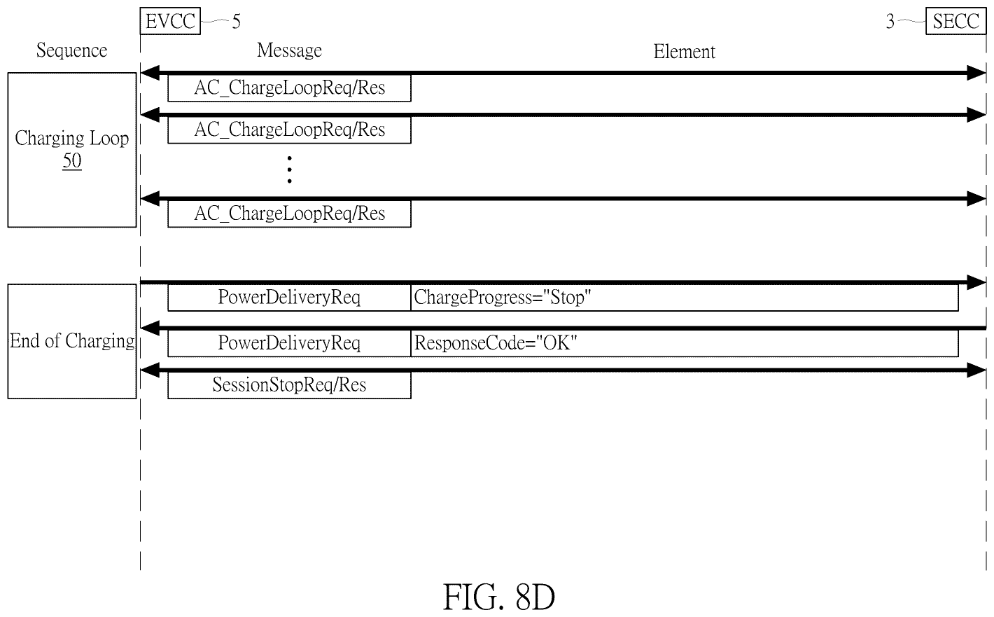

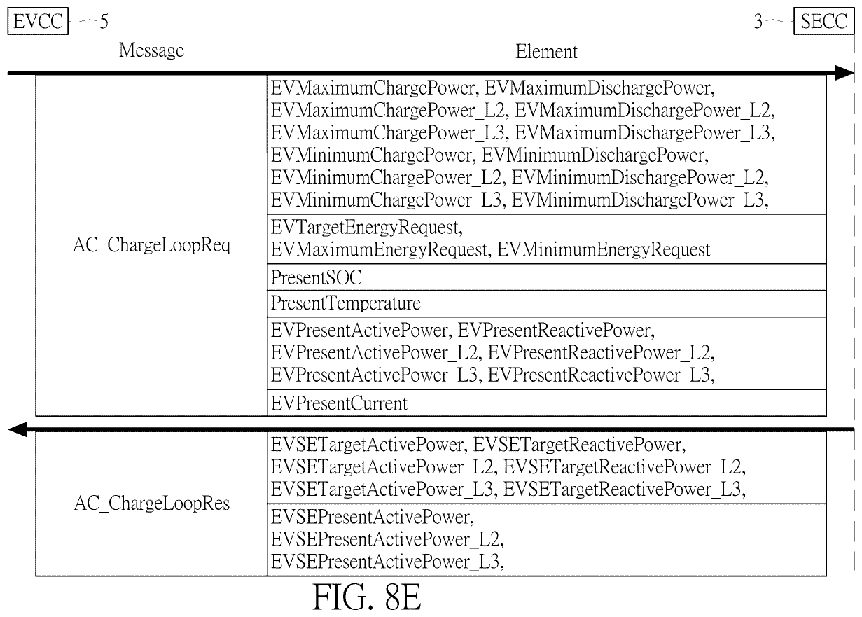

FIGS. 3A to 8E show six embodiments of the present invention applied to the ISO 15118-20 standard. FIGS. 3A to 3E illustrate the signaling sequences of the vehicle-to-grid (V2G) communication session under the “DC Bi-directional Power Transfer (DC_BPT) charging mode” and the default SOC nominal zone boundary estimation method. FIGS. 4A to 4E illustrate the signaling sequences of the V2G communication session under the “DC_BPT charging mode” and the reported SOC nominal zone boundary estimation method. FIGS. 5A to 5E illustrate the signaling sequences of the V2G communication session under the “DC_BPT charging mode” and the discharge curve nominal zone boundary estimation method. FIGS. 6A to 6E illustrate the signaling sequences of the V2G communication session under the “AC Bi-directional Power Transfer (AC_BPT) charging mode” and the default SOC nominal zone boundary estimation method. FIGS. 7A to 7E illustrate the signaling sequences of the V2G communication session under the “AC_BPT charging mode” and the reported SOC nominal zone boundary estimation method. FIGS. 8A to 8E illustrate the signaling sequences of the V2G communication session under the “AC_BPT charging mode” and the discharge curve nominal zone boundary estimation method.

From the left part of FIGS. 3A to 3D, 4A to 4D, 5A to 5D, 6A to 6D, 7A to 7D, and 8A to 8D, it can be seen that the signaling sequences of the communication session include: Communication Setup Session 10, Identification Authorization Session 20, Service Selection Session 30, Target Setting And Charge Scheduling Session 40, Charging Loop Session 50, and End of Charging Communication Session. From the middle part of FIGS. 3A to 3D, 4A to 4D, 5A to 5D, 6A to 6D, 7A to 7D, and 8A to 8D, it can be seen that in each sequence, a request (Req) and response (Res) message pair is exchanged between the EVCC 5 and the SECC 3, and “Req/Res” is a simplified representation of the bidirectional exchange of message pair between the SECC 3 and the EVCC 5. In each message, the present invention adds a signaling element that directs the communication to the target scenario, including the charging mode, and the control mode.

As can be seen from FIGS. 5B and 8B and Table 7, in the signaling sequences, the EVCC 5 transmits the number of charge cycles and the parameters of the discharge curve model in a DischargeCurveParameter element of a message BatteryCharacteristicReportReq. Then, as can be seen in FIGS. 5E and 8E, during charging/discharging, when the EVCC 5 and the SECC 3 exchange ChargeLoop messages, the EVCC 5 sends present temperature information in the PresentTemperature element, which is used not only for temperature-aware charging, but also for battery nominal zone calculation.

The ServiceSelectionReq message in FIG. 3A has a ServiceID element, a ControlMode element, and so on. The ServiceID element can be set to the DC_BPT charging/discharging mode to notify the SECC 3 to execute DC bidirectional power transfer, and if the ServiceID element is set to AC_BPT charging/discharging mode, the SECC 3 will execute AC bidirectional power transfer; the ControlMode element can be set to the dynamic control mode.

The ServiceSelectionRes message in FIG. 3A has a response code (ResponseCode) element. The ResponseCode indicates whether the status is correct or not, and the value of the ResponseCode is ‘OK’ when the status is correct, and the ResponseCode has a warning if the status is incorrect.

A BatteryCharacteristicReportReq message of FIG. 3B has a battery nominal zone boundary estimation method element (BatteryNominalZoneEstimationMethod), which is used to transmit the battery nominal zone boundary estimation method to the SECC 3, and when the BatteryNominalZoneEstimationMethod element has a value of “1”, it refers to the default SOC battery nominal zone estimation method, and when the value is “2”, it refers to the reported SOC battery nominal zone estimation method, and when the value is “3”, it refers to the discharge curve battery nominal zone estimation method. With respect to the battery operating temperature, the BatteryCharacteristicReportReq message also has a minimum charge operating temperature (MinimumChargeOperating Temperature) element, a maximum charge operating temperature (MaximumChargeOperating Temperature) element, a minimum discharge operating temperature (MinimumDischargeOperating Temperature) element, and a maximum discharge operating temperature (MaximumDischargeOperating Temperature) element.

A power delivery request (PowerDeliveryReq) message in FIG. 3C has a charge progress (ChargeProgress) element, and if the ChargeProgress element has a value of “start”, the SECC 3 is notified to enter the DC charge loop (DC_ChargeLoop); if the SECC 3 responds with a ResponseCode element of a power delivery response (PowerDeliveryRes) message, the SECC 3 agrees to enter the DC_ChargeLoop.

FIG. 3D shows multiple DC charging communication loop (DC_ChargeLoopReq/Res) messages to gradually charge or discharge the battery. When the charging/discharging of the battery is completed, the EVCC 5 transmits a charge progress (ChargeProgress) element with a value of “Stop” to the SECC 3, and if the SECC 3 responds with a ResponseCode with a value of “OK”, the charging communication session ends.

FIG. 3E illustrates one DC_ChargeLoopReq/Res message with a DC charging communication loop request message (DC_ChargeLoopReq) and a DC charging communication loop response message (DC_ChargeLoopRes). The DC_ChargeLoopReq message has: a battery maximum charge power (EVMaximumChargePower) element, a battery maximum discharge power (EVMaximumDischargePower) element, a battery minimum charge power (EVMinimumChargePower) element, a battery minimum discharge power (EVMinimumDischargePower) element, a battery maximum charge current (EVMaximumChargeCurrent) element, a battery maximum discharge current (EVMaximumDischargeCurrent) element, a battery maximum voltage (EVMaximum Voltage) element, and a battery minimum voltage (EVMinimum Voltage) element to notify the SECC 3 of the characteristics of the battery.

FIG. 3E further illustrates the DC_ChargeLoopReq message with the PresentSOC element, the PresentTemperature element, an EVPresent Voltage element, and an EVPresentCurrent element of the battery to notify the SECC 3 of the current states of the battery.

The DC charging communication loop response message (DC_ChargeLoopRes) of FIG. 3E has the following feature elements for the EVSE 2: an EVSE maximum charge power element (EVSEMaximumChargePower), an EVSE maximum discharge power element (EVSEMaximumDischargePower), an EVSE minimum charge power element (EVSEMinimumChargePower), an EVSE minimum discharge power element (EVSEMinimumDischargePower), an EVSE maximum charge current element (EVSEMaximumChargeCurrent), an EVSE maximum discharge current element (EVSEMaximumDischargeCurrent), an EVSE maximum voltage element (EVSEMaximum Voltage), and an EVSE minimum voltage element (EVSEMinimum Voltage), and thereby the EVSE 2 can respond to and notify the EVCC 5 of the features of the EVSE 2.

FIG. 3E further has feature elements of the EVSE 2 such as an EVSE present voltage element (EVSEPresentVoltage) and an EVSE present current element (EVSEPresentCurrent), and thereby the EVSE 2 can notify the EVCC 5 of the present states of the EVSE 2.

FIGS. 4A to 5E are similar to the above FIGS. 3A to 3E, and they are all about DC charging, so they are not described here. FIGS. 6A to 8E are all about AC charging, in which FIGS. 6D to 6E, FIGS. 7D to 7E, and FIGS. 8D to 8E all have the AC_ChargeLoop and its related information and elements, except that FIGS. 6A to 8E are similar to the above FIGS. 3A to 3E, and therefore FIGS. 6A to 8E are not described in detail herein.

TABLE 1
Schema and type definition for a BatteryCharacteristicsReportReq
message

| Element Name | Element Semantics |
|---|---|
| BatteryType | This element is for an EV to reveal the |
| | chemical materials of the battery including 6 |
| | types, namely, Lead-acid, Nickel-based, |
| | ambient-temperature Lithium, Sodium-beta, |
| | high-temperature Lithium, metal/air, and |
| | Zinc/Halogen. |
| BatteryOperatingTemper- | The operating temperature area is often |
| ature | provided by a battery data sheet and can be |
| | stored in EV's memory. |
| BatteryNominalZone- | The EVSE uses this method to estimate the |
| EstimationMethod | discharge/charge boundary of the battery |
| | nominal zone when planning the charge |
| | schedule in dynamic mode. The method can |
| | be the default SOC, the reported SOC, or the |
| | discharge curve nominal zone boundary |
| | estimation method. |
| NominalZoneBound- | Estimated SOCs of the battery nominal zone |
| arySOC | boundary are mandatory for the reported SOC |
| | nominal zone boundary estimation method. |
| DischargeCurveParamter | This element is mandatory for the discharge |
| | curve nominal zone boundary estimation |
| | method. These parameters are used by the |
| | EVSE to derive the discharge curve of a new |
| | battery under reference temperature and |
| | reference charging current. An EVSE can |
| | calibrate the discharge curve under dynamic |
| | charging current, temperature, and charging |
| | cycles. The battery nominal zone boundary |
| | can be deduced based on the discharge curve |
| | model. |

TABLE 2
Schema and type definition for a BatteryCharacteristicReportRes
message

| Element Name | Element Semantics |
|---|---|
| ResponseCode | ResponseCode indicates acknowledgment status, |
| | including the following options: |
| | OK: When EVCC transmits valid values of operating |
| | temperature boundary. |
| | OK_OperatingTemperatureSetToDefaultValue: When |
| | EVCC does not include values of operating temperature |
| | boundary. In this case, SECC sets the values of operating |
| | temperature boundary to the default value according to |
| | the reported battery type. |

TABLE 3
Schema and type definition for newly defined elements in
DC_ChargeLoopReq, AC_ChargeLoopReq messages

| Element Name | Element Semantics |
|---|---|
| PresentTemperature | This element is indicated for EV to report |
| | temperature during charge loop. |
| EVPresentCurrent | This element is indicated for EV to report charging |
| | current during charge loop. |

TABLE 4
Schema and type definition for newly defined
elements in a DC_ChargeLoopRes message

| Element Name | Element Semantics |
|---|---|
| EVSEPresentCurrent | This element is indicated for EVSE to reveal its |
| | output charging current during charge loop. |

TABLE 5
Schema and type definition for an OperatingTemperatureType
element type

| Element Name | Element Semantics |
|---|---|
| BatteryChargeOperating | The upper boundary of the operating |
| TemperatureUpperBound | temperature range when EV's battery is |
| | being charged. |
| BatteryChargeOperating | The lower boundary of the operating |
| TemperatureLowerBound | temperature range when EV's battery is |
| | being charged. |
| BatteryDischargeOperating | The upper boundary of the operating |
| TemperatureUpperBound | temperature range when EV's battery is |
| | being discharged. |
| BatteryDischargeOperating | The lower boundary of the operating |
| TemperatureLowerBound | temperature range when EV's battery is |
| | being discharged. |

TABLE 6
Schema and type definition for a BoundarySOCType element type

| Element Name | Element Semantics |
|---|---|
| NominalZoneUpperBoundarySOC | The upper boundary of the operating |
| | temperature range when EV's battery |
| | is being charged. |
| NominalZoneLowerBoundarySOC | The lower boundary of the operating |
| | temperature range when EV's battery |
| | is being discharged. |

TABLE 7
Schema and type definition for a DischargeCurveParameterType
element type

| Element Name | Element Semantics |
|---|---|
| BatteryChargeCycle | This element counts the times the complete |
| | capacity of battery is used. A charge cycle does |
| | not necessarily mean charging in a single |
| | discharge. A battery may equivalently discharge |
| | a complete capacity in multiple discharges. |
| FullyChargedVoltage | This element is indicated for EV to reveal its |
| | battery's fully charged voltage which is a |
| | discharge curve parameter. |
| EndofExponen- | This element is indicated for EV to reveal its |
| tialVoltage | battery's voltage at the end of the exponential |
| | relationship between battery voltage and SOC |
| | which is a discharge curve parameter. |
| EndofExponen- | This element is indicated for EV to reveal its |
| tialCapacity | battery's SOC at the end of the exponential |
| | relationship between battery voltage and SOC |
| | which is a discharge curve parameter. |
| EndofNominalVoltage | This element is indicated for EV to reveal its |
| | battery's voltages at the boundary of the battery |
| | nominal zone which is a discharge curve |
| | parameter. |
| EndofNominalCapac- | This element is indicated for EV to reveal its |
| ity | battery's SOC at the boundary of the battery |
| | nominal zone which is a discharge curve |
| | parameter. |
| MaximumCapacity | This element is indicated for EV to reveal its |
| | battery's maximum capacity which is a |
| | discharge curve parameter. |
| InternalResistance | This element is indicated for EV to reveal its |
| | battery's internal resistance which is a discharge |
| | curve parameter. |

In summary, the present invention discloses that the SECC 3 of the EVSE 2 executes the dynamic control mode, wherein the SECC 3 obtains battery related information of the EV 4 through the EVCC 5, and adopts one of three battery nominal zone boundary estimation methods according to the instructions of the EVCC 5, and the EVCC 5 further provides corresponding data of the adopted battery nominal zone boundary estimation method to enable the SECC 3 to accordingly estimate a battery nominal zone for charging and discharging, and to plan/adjust and execute a charging schedule taking into account the EV battery charging and discharging nominal zone which prevents accelerated battery degradation due to exceeding the nominal zone during battery charging or discharging, and thereby the objective of the present invention can be achieved.

What is claimed is:

1. A method of electric vehicle (EV) battery nominal zone-aware charging communication, executed by a supply equipment communication controller (SECC) of an electric vehicle supply equipment (EVSE), the SECC establishing a communication connection with an EV Communication Controller (EVCC) of an EV, and the SECC executing a dynamic control mode, and the method of EV nominal zone-aware charging communication comprising the following steps:
(a) receiving a service selection message from the EVCC to confirm that a battery of the EV is to be charged or discharged in a DC bidirectional power transfer charge/discharge mode or in an AC bidirectional power transfer charge/discharge mode;
(b) receiving from the EVCC a battery characteristics report request message for the battery containing a battery type element, a battery nominal zone boundary estimation method and a battery operating temperature, or either one of a nominal zone boundary state of charge (SOC) and a discharge curve parameter;
(c) based on the messages received from the EVCC, estimating a nominal zone of the battery for charging and discharging and planning a charging schedule for EV battery nominal zone-aware charging; and
(d) during the charging and discharging of the battery, the SECC receiving from the EVCC a present SOC, a present temperature, a present voltage, and a present current of the battery in order to execute the charging schedule for the EV battery nominal zone-aware charging.

2. The method of EV battery nominal zone-aware charging communication as claimed in claim 1, wherein in step (b), when the battery nominal zone boundary estimation method is a default SOC battery nominal zone estimation method, a boundary of the battery nominal zone of the battery is further set to be a lower boundary SOC value and an upper boundary SOC value, so as to avoid the battery SOC being lower than the lower boundary SOC value or higher than the upper boundary SOC value during charging and discharging of the battery.

3. The method of EV battery nominal zone-aware charging communication as claimed in claim 1, wherein in step (b), when the battery nominal zone boundary estimation method is a reported SOC nominal zone boundary estimation method, SOC values of a boundary of the battery nominal zone of the battery are further obtained from a battery characteristics report request message sent by the EVCC for calculating the battery nominal zone of the battery, so as to avoid a charging/discharging profile of the battery exceeding the boundary of the battery nominal zone of the battery during charging/discharging the battery.

4. The method of EV battery nominal zone-aware charging communication as claimed in claim 1, wherein in step (b), when the battery nominal zone boundary estimation method is a discharge curve nominal zone boundary estimation method, the SECC adopts a battery discharge curve model in estimating a boundary of the battery nominal zone of the battery to calculate a present discharge profile, and estimates a nominal charge/discharge zone for the battery based on the present discharge profile.

5. The method of EV battery nominal zone-aware charging communication as claimed in claim 4, in step (a), the battery discharge curve model further taking into account a battery type of the battery, number of charging cycles, temperature, and charging and discharging currents for the SECC to calculate the present discharge profile with parameters of temperature and charging/discharging current.

6. The method of EV battery nominal zone-aware charging communication as claimed in claim 1, wherein in step (b), the battery operating temperature is further subdivided into a minimum charging operating temperature, a maximum charging operating temperature, a minimum charging operating temperature, and a maximum charging operating temperature.

7. The method of EV battery nominal zone-aware charging communication as claimed in claim 1, wherein when the battery nominal zone boundary estimation method is a reported SOC nominal zone boundary estimation method, the EVCC provides SOC values of a boundary of the battery nominal zone of the battery to the SECC; and when the battery nominal zone boundary estimation method is a discharge curve nominal zone boundary estimation method, the EVCC provides the battery discharge curve model parameters to the SECC.

8. The method of EV battery nominal zone-aware charging communication as claimed in claim 1, wherein when charging/discharging the battery of the EV in the DC bidirectional power transfer charge/discharge mode, in step (d) during the charging and discharging of the battery, the SECC provides a present EVSE voltage and a present EVSE current to the EVCC.

9. The method of EV battery nominal zone-aware charging communication as claimed in claim 1, wherein when charging/discharging the battery of the EV in the AC bidirectional power transfer charge/discharge mode, in step (d) during the charging and discharging of the battery, the SECC provides the EVCC with a present active power of the EVSE.

10. The method of EV battery nominal zone-aware charging communication as claimed in claim 2, wherein the lower boundary SOC value is 15% and the upper boundary SOC value is 85%.
